(19) United States
(12) Patent Application Publication
(10) Pub. No.: US 2005/0051587 A1
(43) Pub. Date: Mar. 10, 2005

(54) Pill box

(76) Inventor: Man Kit Elvin Kan, Hong Kong (CN)

Correspondence Address: Mr. Eric Chan, 42 Pin Oaks Drive, Phoenixville, PA, 19460, US

(21) Appl. No.: 10/929,868

(22) Filed: Aug. 31, 2004

(30) Foreign Application Priority Data
Sep. 4, 2003 (HK) 03106307.2

(51) Int. Cl. B26F 3/00

(52) U.S. Cl. 225/103; 225/96.5; 225/104; 30/124

(57) ABSTRACT

The present invention relates to a pill box for splitting pills into halves. The pill box comprises a cover and a base which are connected pivotally by a staff. The cover has a blade holder inside, which has a plug pin at the bottom. At the bottom of the cover, there is a partition with an opening. The base has a pill receptacle and a slot. When the blade holder moves down, the blade and the plug pin pass through the opening. The blade cuts at the position of the pill receptacle and the plug pin plugs into the slot. The cover and the base are locked together. When the blade holder moves up and the plug pin completely moves out from the slot, the cover or the base can rotate out with the staff as a pivot. The present invention is safe, reliable, small and portable.

### TECHNICAL FIELD

The present invention relates to a pill box and more particularly pertains to a portable pill box with a blade for splitting pills into halves.

### BACKGROUND OF THE INVENTION

People who are on long term medication, such as those who suffer from chronic diseases and the elderly, usually need to take medication several times a day. When they need to take pills in halves, they often have to use fruit knives or other tools to split the pills into halves as their hands are not strong enough to do so. This takes time and is energy consuming and dangerous. Further, children usually take lower dosage of medication and so they are more likely to take pills in halves. If sharp tools are required to split the pills into pieces every time medication is taken, even older children will need to seek assistance from adults to split the pills as they are incapable to do so on their own. To adults, it is also inconvenient and dangerous.

To solve the aforesaid problems, U.S. Pat. No. 5,118,021A discloses a pill splitter for splitting pills into pieces in a convenient way. As illustrated in FIG. 1, a metal blade is disposed inside the cover of the pill splitter. To split a pill, place the pill in the receptacle of the pill splitter and close the cover, the metal blade then split the pill in the receptacle correspondingly. China Invention Patent Publication No. CN1408337A also discloses a pill splitter for splitting pills into halves in a convenient way. As illustrated in FIGS. 2 and 3, the structure of the splitter is similar to that of the aforesaid U.S. Pat. No. 5,118,021A. The only difference is that oblique slots are provided in the receptacle to hold the pill in place, so that the blade disposed in the cover can precisely split the pill into halves. There are pill splitters of various designs currently available in the marketplace, but all of them adopt the same splitting structure as aforesaid, that is, the blade is exposed when the cover is opened. Users may easily cut their fingers if they are not careful when using the splitters, so such splitters are only suitable for adults. If children use the splitters on their own, or if they play with the splitters as toys when the adults are not aware, it will be very dangerous and may cause unnecessary injuries. Thus, the existing pill splitters present potential threats to the elderly and children who need to take pills in halves frequently, and the pill splitters are incapable of satisfying the needs of the consumers.

### BRIEF SUMMARY OF THE INVENTION

In view of the aforesaid disadvantages now present in the prior art, the present invention provides a portable, safe and reliable pill box which can split pills into halves and store the pills.

To attain this, the present invention generally comprises a cover with a blade, a base with a pill receptacle, and a staff connecting the cover and the base. Inside the cover, there is a blade holder with a metal blade thereon and an oblong-shaped plug pin thereunder. On the top of the cover, there is a press-button device to control the blade holder to move upward and downward. At the bottom of the cover, there is a partition with an elongated, opening which allows the blade to pass through when the blade holder moves downward. To allow the plug pin to pass through when the blade holder moves downward, the opening has an enlarged section in oblong shape corresponding with that of the plug pin. The base has a pill receptacle and a slot with cavity in oblong shape. The pill receptacle is disposed in the position corresponding with that at which the blade cuts when the blade holder moves downward. The position and the shape of the slot correspond with those of plug pin and the plug pin inserts into the slot when the blade holder moves downward. The cover and the base are connected by the staff vertically and pivotally. When the plug pin inserts into the slot, the cover and the base are locked together and are unable to rotate out to the left or to the right. When the blade holder moves upward and the plug pin completely moves out from the slot, the cover or the base can rotate out to the left or to the right as against each other with the staff serving as a pivot. When the cover or the base rotates out, the blade retreats to a position above the partition and becomes unexposed and the plug pin no longer fits into the slot and so the blade holder cannot move downward.

The aforesaid press-button device comprises a press-button, a button-lock and a spring. The press-button is connected with the blade holder by plugging or interlocking. The spring is disposed at the connection between the press-button and the blade holder. The button-lock locks the press-button in a pressed position, so that the spring is compressed under pressure and the blade holder is in a downward position. That is, the plug pin inserts into the slot and the blade cuts at the pill receptacle. When the button-lock is unlocked, the spring is extended as the pressure releases. As a result, the press-button springs up and brings the blade holder to move upward. The plug pin moves out from the slot and the blade retreats to the position above the partition and becomes unexposed. The button-lock may take the form of a manual mechanical structure. For example, the button-lock may take the form of a push button which is connected to the press-button by hinging or interlocking and the user may lock or unlock the press-button by pushing the push button. The button-lock may also take the form of a bolt to lock the press-button and the user may lock or unlock the press-button by engaging or disengaging the bolt. The button-lock may also use the ratchet wheel mechanism of a retractable ball pen and the user may lock the press-button by pressing the button once and unlock by pressing again. Other means such as electronic or magnetic switching controls may also be applied to lock and unlock the press-button and as the applications are obvious, these are not described in detail herein.

Further, the bottom of the press-button has a pin and the top of the blade holder has a hollow pin and the pin fits into the hollow pin. The press-button is connected to the blade holder.

At least one pair of guiding bars are disposed on the top of the partition with the blade holder fit in between the pair or pairs of guiding bars. The guiding bars sets the limits on the vertical movement of the blade holder.

The partition is securely connected to the cover by means of rivets, screws, adhesives and the like.

The metal blade is securely mounted to the blade holder by means of screws, adhesives and the like.

A pill holder in the shape of a water droplet is disposed inside the pill receptacle for holding pills of various sizes.

A pill container with a removable lid is provided on one side of the top of the cover for storage of the split pills.

An integrated circuit may be installed thereon to sound alarms to remind patients to take medication on time.

All components of the pill box, except for the metal blade and the spring, may be made of any kind of materials such as hard plastic materials. The spring can be made of any elastic material.

The pill box can be in any shape. For the purposes of reducing angularity and providing more space for splitting and storage, oval shape is considered as the most preferable shape.

When the pill box is placed in a user's pocket and not in use, the button-lock locks the press-button in a pressed position. The spring is compressed under pressure and the blade holder is in a downward position. That is, the plug pin inserts into the slot and the blade cuts at the pill receptacle. Therefore, the cover and the base are locked and cannot rotate out to the left or to the right. The blade is hidden inside the pill box and is unexposed.

To use the pill box to split a pill into halves, the user first unlocks the button-lock. The spring is extended as the pressure releases. The press-button springs up and brings the blade holder to move upward. The plug pin moves out from the slot and the blade retreats to the position above the partition and becomes unexposed. As a result, the cover and the base become unlocked and any one of them can rotate out to the left or to the right as against each other with the staff serving as a pivot. When the cover or the base rotates out, the user can put the pill into the pill holder for splitting. When either the cover or the base rotates out, the blade retreats to a position above the partition and becomes unexposed and owing to a change in orientation, the plug pin no longer fits into the slot and so the blade holder cannot move downward. After placing the pill in the pill holder, the user rotates the cover or the base back to the original position and the cover and the base align with each other. The user then tilts the pill box forward. The pill will then be placed securely at the front end of the pill holder automatically. The user then presses the sprung press-button. The spring is compressed under pressure, and the blade holder goes down and brings the blade with it to cut into the pill receptacle, thus splitting the pill in the pill holder into halves. While the plug pin inserts into the slot, the cover and the base are locked and cannot rotate out. The blade is hidden inside the pill box and is unexposed. Repeat the aforesaid steps and rotate the base out to take out the pill which has been split into halves for use or for storage in the pill container.

It is an object of the present invention to provide a pill box capable of splitting pills into halves and storing the pills.

It is another object of the present invention to provide a portable, safe and reliable pill box.

It is a further object of the present invention to provide a pill box with unexposed blade design.

It is a further object of the present invention to provide a pill box which is suitable for different kinds of people including adults, the elderly and children.

### BRIEF DESCRIPTION OF THE DRAWINGS

FIG. 1 is a perspective view of a known pill splitter;

FIG. 2 is a side elevational view of another known pill splitter;

FIG. 3 is a top plan view of FIG. 2;

FIG. 4 is an exploded view of the components of the present invention;

FIG. 5 is an exploded view of the components of the present invention in another perspective;

FIG. 6 is a perspective view of the embodiment of the present invention.

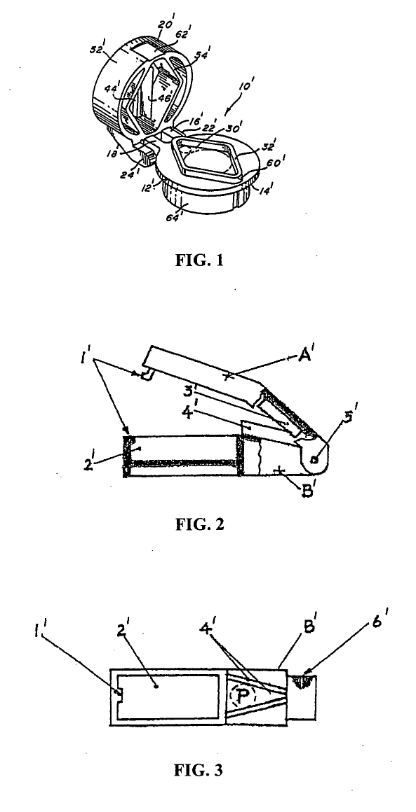

### DETAILED DESCRIPTION OF THE INVENTION

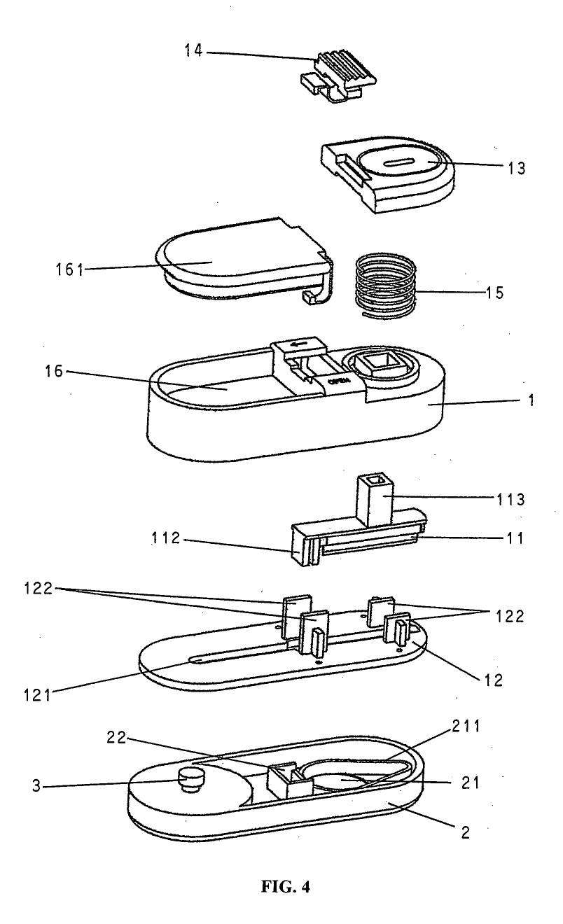

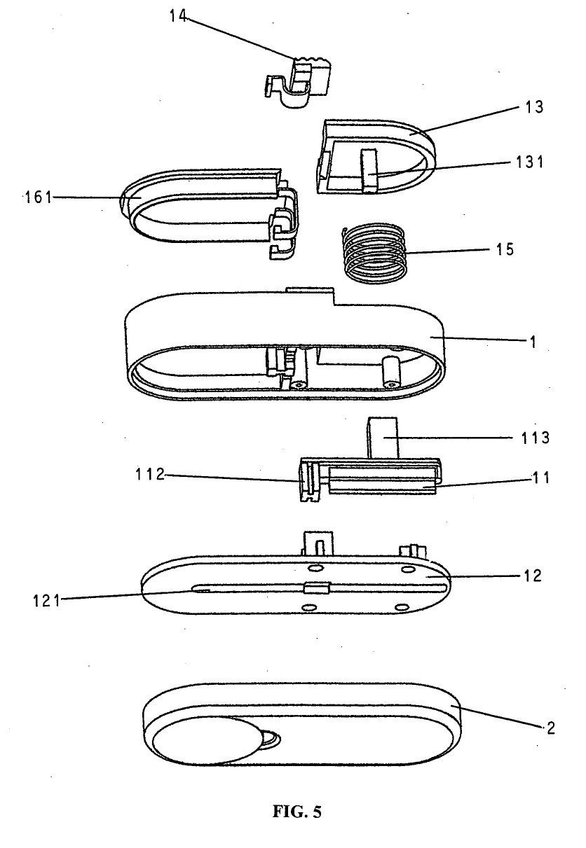

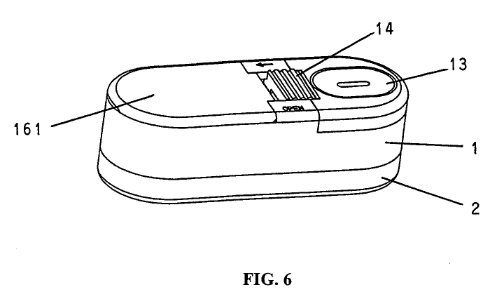

As illustrated in FIG. 6, the embodiment of the present invention is a small-sized and oval-shaped pill box which can be conveniently placed in a user's pocket. All components are made of hard plastic materials except for several metal components. As illustrated in FIGS. 4 and 5, the pill box generally comprises a cover 1 with a blade 111, a base 2 with a pill receptacle 21 and a staff 3 connecting the two. The cover 1 has a blade holder 11 disposed inside. The blade holder 11 is controlled by a press-button device to move upward and downward. A metal blade 111 is securely mounted to the blade holder 11 by means of screws. The bottom of the blade holder 11 has an oblong-shaped plug pin 112. The blade holder 11 has a hollow pin 113 thereon. The press-button device comprises a press-button 13, a push-button 14 and a metal spring 15. The bottom of the press-button 13 has a pin 131 which can plug into the hollow pin 113. The press-button 13 and blade holder 11 can be connected together by plugging. The spring 15 is disposed at the connection between the press-button 13 and the blade holder 11. The push-button 14 locks the press-button 13 and keeps the press-button 13 in a pressed position. The bottom of the cover 1 has a partition 12 which is securely connected to the cover 1 by means of rivets. Two pairs of guiding bars 122 are provided above the partition 12. The blade holder 11 fits in between the pairs of guiding bars 122. The guiding bars 122 sets the limits on the vertical movement of the blade holder 11. The partition 12 has an elongated opening 121 which allows the blade 111 to pass through when the blade holder 11 moves downward. The opening 121 has an enlarged section in oblong shape corresponding with that of the plug pin 112 so as to allow the plug pin 112 to pass through when the blade holder 11 moves downward. The base 2 has a pill receptacle 21 at a position corresponding with that at which the blade 111 cuts when the blade holder 11 moves downward. A pill holder 211 in the shape of a water droplet is provided at that position in the pill receptacle 21 for holding pills of various sizes. The base 2 has a slot 22 with cavity in oblong shape at a position corresponding with that of the plug pin 112 when the blade holder 11 moves downward. The cover 1 and the base 2 are connected by the staff 3 vertically and pivotally. A pill container 16 with a removable lid 161 is provided on one side of the top of the cover 1.

To use the pill box, push the push-button 14 to the left to unlock the press-button 13. The spring 15 is extended as the pressure releases. As a result, the press-button 13 springs up and brings the blade holder 11 to move upward. The blade 111 is retreated to a position above the partition 12 and the plug pin 112 completely moves out from the slot 22. The cover 1 and the base 2 are unlocked and can rotate out to the left or to the right as against each other with the staff 3 serving as a pivot. Rotate the base 2 out to an open position and put the pill into the pill holder 211 for splitting into halves. When the base 2 rotates out, the blade 111 is unexposed as it has retreated to the position above the partition 12. Moreover, as the plug pin 112 has rotated to a different orientation, it can no longer fit into the slot 22 and cannot press downward. As a result, the blade holder 11 cannot move downward and the blade 111 cannot move downward to be exposed. After placing the pill needed to be split into halves in place, rotate the base 2 back to the original position which aligns with the cover 1 and then tilt the pill box forward. The pill will then be placed securely in the front end of the pill holder 211 automatically. The user then presses the sprung press-button 13. The spring 15 is compressed under pressure. The blade holder 11 brings along the blade 111, which cuts into the pill receptacle 21 and splits the pill which placed in the pill holder 211 into halves. While the plug pin 112 inserts into the slot 22, the cover 1 and the base 2 are locked and cannot rotate out. The blade 111 is hidden inside the pill box and is unexposed. Repeat the aforesaid steps and rotate the base 2 out to an open position and take out the split pills for use or place them into the pill container 16 for reserve.

As to a further discussion of the manner of usage and operation of the present invention, the same should be apparent from the above description. Accordingly, no further discussion relating to the manner of usage and operation is provided.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

The present invention is capable of other embodiments and of being practiced and carried out in various ways. It is to be understood that the phraseology and terminology employed herein are for the purpose of description and should not be regarded as limiting.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to falling within the scope of the invention.

1. A pill box comprising:
a cover which has a blade holder disposed inside with a metal blade thereon and an oblong-shaped plug pin thereunder, a press-button device disposed on the top to control the blade holder to move upward and downward, and a partition disposed at the bottom with an elongated opening having an enlarged section in oblong shape corresponding with that of the plug pin, and the blade and the plug pin pass through the opening when the blade holder moves downward;
a base which has a pill receptacle disposed inside in a position corresponding with that at which the blade cuts when the blade holder moves downward, and a slot with cavity in oblong shape corresponding with that of the plug pin and the plug pin inserts into the slot when the blade holder moves downward; and
a staff which connects the cover and the base vertically, and when the plug pin inserts into the slot, the cover and the base are locked and cannot rotate out, and when the plug pin completely moves out from the slot, the blade retreats to a position above the partition and becomes unexposed, the cover or the base can rotate out to the left or right as against each other with the staff serving as a pivot, and when the cover or the base rotates out, the plug pin cannot fit into the slot and the blade holder cannot move downward.

2. A pill box of claim 1, wherein the press-button device further comprising
a press-button which connects to the blade holder by plugging or interlocking;
a spring which is disposed at the connection between the press-button and the blade holder;
a button-lock which locks the press-button in a pressed position with the spring being compressed under pressure and the blade holder being in a downward position, and when the button-lock is unlocked, the spring is extended as the pressure releases and the press-button springs up and brings the blade holder to move upward.

3. A pill box of claim 1 or 2, wherein the bottom of the press-button has a pin and the top of the blade holder has a hollow pin and the pin can fit into the hollow pin.

4. A pill box of claim 1 or 2, wherein at least one pair of guiding bars are disposed on the top of the partition with the blade holder fit in between the pair or pairs of guiding bars, which sets the limits on the vertical movement of the blade holder.

5. A pill box of claim 1 or 2, wherein the partition is securely connected to the cover by means of rivets or screws or adhesives.

6. A pill box of claim 4, wherein the partition is securely connected to the cover by means of rivets or screws or adhesives.

7. A pill box of claim 1 or 2, wherein the metal blade is securely mounted to the blade holder by means of screws or adhesives.

8. A pill box of claim 3, wherein the metal blade is securely mounted to the blade holder by means of screws or adhesives.

9. A pill box of claim 4, wherein the metal blade is securely mounted to the blade holder by means of screws or adhesives.

10. A pill box of claim 5, wherein the metal blade is securely mounted to the blade holder by means of screws or adhesives.

11. A pill box of claim 6, wherein the metal blade is securely mounted to the blade holder by means of screws or adhesives.

12. A pill box of claim 1, wherein a pill holder in the shape of a water droplet is disposed inside the pill receptacle for holding pills of various sizes.

13. A pill box of claim 1, wherein a pill container with a removable lid is provided on one side of the top of the cover for storage of the split pills.

14. A pill box of claim 1, wherein an integrated circuit is installed thereon to sound alarms to remind patients to take medication on time.

15. A pill box of claim 1, wherein the pill box is in oval shape.
